(19) United States
(12) Patent Application Publication
(10) Pub. No.: US 2007/0132587 A1
(43) Pub. Date: Jun. 14, 2007

(54) Time domain embedding of application information in an RFID response stream

(75) Inventors: Joshua R. Smith, Seattle, WA (US); James A. Landay, Seattle, WA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/304,511

(22) Filed: Dec. 14, 2005

(51) Int. Cl. G08B 13/14; H04Q 5/22; G08B 1/08

(52) U.S. Cl. 340/572.1; 340/10.1; 340/539.26

(57) ABSTRACT

According to some embodiments, a radio frequency identification (RFID) tag communicates additional information using a series of selective responses. For example, one or more sensors may be coupled to an RFID tag. The RFID tag responds to multiple RFID polls using a vector of selective responses to encode sensor state. A selective response may include a response with an identification code, a non-response, and a response with a different identification code.

### BACKGROUND

### Description of the Related Art

New uses of radio frequency identification (RFID) technology is the subject of many research and development projects. An RFID tag is typically an integrated circuit attached to an antenna. The tag may be passive or active. Passive RFID tags typically have no power source, and rely upon the energy delivered by an interrogation signal to transmit a stream of information. Active RFID tags may have a power source such as a direct current (DC) battery.

An RFID reader sends out electromagnetic waves to an RFID tag, which induces a current in the tag's antenna. The RFID reader may be a fixed device or a portable device. Additional information about items attached to the tag can be stored on the tag. The tag modulates the waves and sends information back to the RFID reader. Information may be exchanged between the tag and the RFID reader through either inductive coupling or backscatter. RFID systems may use many different frequencies, but generally the most common are low (around 125 KHz), high (13.56 MHz), ultra-high (850-900 MHz), and microwave (2.45 Ghz).

### DESCRIPTION OF THE DRAWINGS

The present invention may be better understood, and its numerous features and advantages made apparent to those skilled in the art by referencing the accompanying drawings.

FIG. 1 illustrates a novel use of radio frequency identification (RFID) technology according to an embodiment of the present invention.

FIG. 2 illustrates an RFID tag according to an embodiment of the present invention.

FIG. 3 illustrates response processing system according to an embodiment of the present invention.

FIGS. 4 and 5 illustrate response encoding diagrams according to embodiments of the present invention.

FIG. 6 illustrates a flow diagram performed by an RFID tag according to an embodiment of the present invention.

FIG. 7 illustrates a flow diagram of a response processing system according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, state machine and the like that manipulate and/or transform data represented as physical, such as electronic, quantities into other data similarly represented as physical quantities.

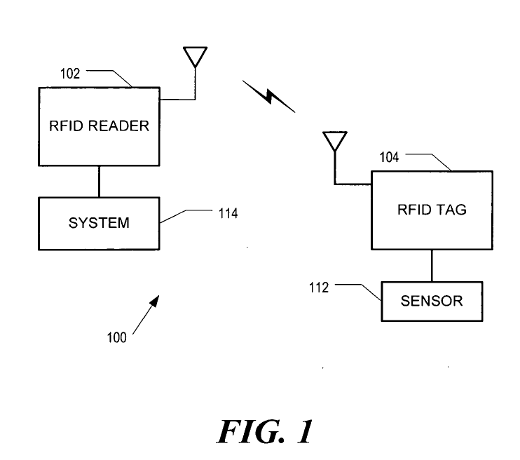

FIG. 1 illustrates a novel use of radio frequency identification (RFID) technology according to an embodiment of the present invention. In the illustrated system 100, an RFID reader 102 may send multiple polls to an RFID tag 104 by transmitting appropriate radio frequency (RF) signals to RFID tag 104. According to an embodiment of the present invention, RFID tag 104 selectively responds to each of the multiple polls. A selective response may be a response that includes an identification code, a response that includes another identification code, or a non-response. By selectively responding to the multiple polls with different selective responses in a pattern, RFID tag 104 may encode additional information about a device attached to RFID tag 104, for example, a current state of a sensor 112 attached to RFID tag 104.

Sensor 112 may track environmental information such as temperature, humidity, pressure and the like. Sensor 112 may track other types of information including location, time, product information, and the like. RFID tag 104 and sensor 112 are generally referred to herein as separate items, but may also be packaged as a single integrated unit. Sensor data may be encoded in an analog fashion. For example, a proportion of selective responses with a first identification code versus selective responses with a second identification code computed, for example, in a sliding time window, may indicate the sensor data.

RFID reader 102, and/or an associated response processing system 114, may process a series of selective responses to determine a pattern of selective responses and/or un-encode the information. Associated response processing system 114 may be coupled to RFID reader 102 directly or indirectly, locally or remotely, wired or wirelessly, or may be combined with RFID reader 102 into a single integrated unit. According to some embodiments of the present invention, received selective responses may be accumulated and sensor data decoded at a later time.

According to one embodiment of the present invention, RFID reader 102 sends multiple RFID polls to RFID tag 104 and records a series of selective responses received from RFID tag 104. Whenever a selective response is received, a time stamp is recorded and/or an identification code received in the response is recorded. By processing the different selective responses received, a pattern may be derived from the selective responses. The pattern may be decoded to determine the sensor information. In an alternate embodiment of the present invention, selective responses are decoded upon receipt, without recording timestamps or identification codes.

An RFID read event includes an RFID poll from a reader to a tag and an RFID response from the tag to the reader. According to standard RFID protocols, each RFID read event is typically an independent event. By treating multiple read events jointly, embodiments of the present invention are able to communicate additional information by encoding in and decoding from a stream of RFID read events, without modifying existing protocol or reader hardware. According to embodiments of the present invention, the present generation of RFID protocols is expanded to allow communication of additional data, such as sensor information, while preserving investments in existing infrastructure and standards.

According to one embodiment of the present invention, accommodations can be made in RFID reader anti-collision protocol to allow reading sensor data from multiple different tags. One approach is to singulate a first tag (that is, silence all tags but one), extract sensor data for some period from the singulated tag, then silence that tag, enable the second, extract sensor data from the second, and so forth.

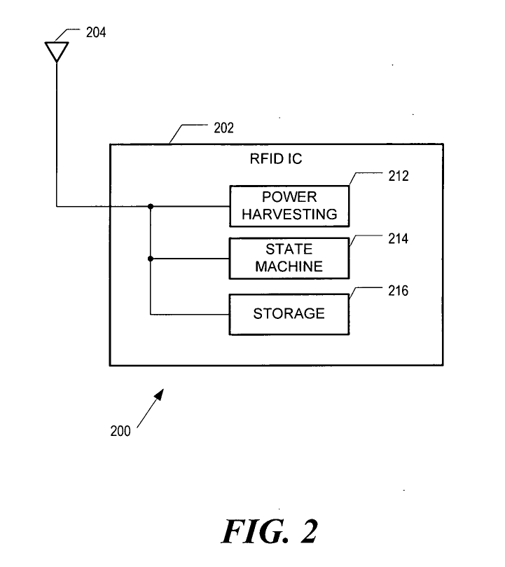

FIG. 2 illustrates an RFID tag according to an embodiment of the present invention. RFID tag 200 includes an RFID integrated circuit (IC) 202 coupled to an antenna 204. RFID IC 202 receives and processes an RFID signal from an RFID reader (not shown). To access RFID IC 202, an interrogation signal may be transmitted by the RFID reader in a vicinity of antenna 204.

RFID IC 202 may include power harvesting and voltage processing circuitry 212, a processor or state machine 214, and storage 216. Power harvesting and voltage processing circuitry 212 may include protection circuitry such as a diode (not shown) and a voltage regulator (not shown) and an inductor (not shown) to receive an RFID signal and charge one or more capacitors (not shown) to generate power to operate RFID IC 202, although embodiments of the invention are not limited in this context. State machine 214 controls selective responses to RFID polls to encode additional information, for example, current sensor state, in the response stream. Storage 216 may include non-volatile re-writable memory, although embodiments of the invention are not limited in this context. Storage 216 may contain additional information, for example, sensor state, to be encoded into a series of responses and non-responses to multiple RFID polls. Storage 216 may also contain one or more identification codes, a key for decryption, a device identification for signal authentication, and other such information.

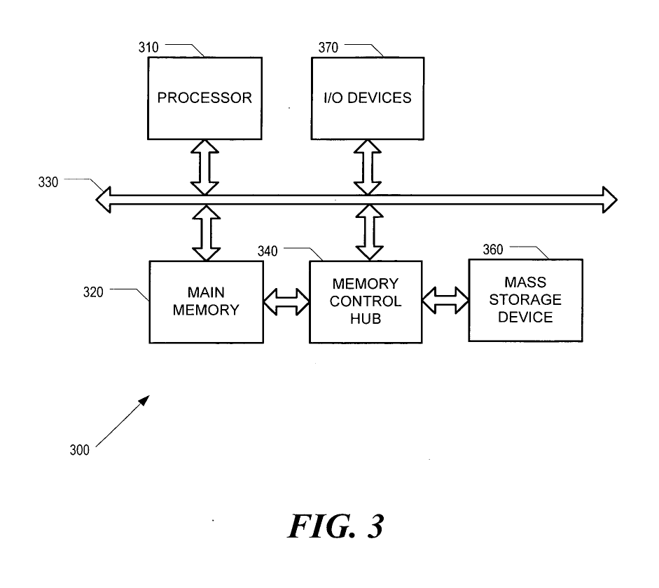

FIG. 3 illustrates response processing system according to an embodiment of the present invention. System 300 processes a selective responses to decode additional information from an RFID tag. System 300 includes a processor 310 coupled to a main memory 320 by a bus 330. Main memory 320 may include a random-access-memory (RAM) and be coupled to a memory control hub 340. Memory control hub 340 may also be coupled to bus 330 and to a mass storage device 360. Mass storage device 360 may be a hard disk drive, a floppy disk drive, a compact disc (CD) drive, a Flash memory (NAND and NOR types, including multiple bits per cell), or any other existing or future memory device for mass storage of information. Memory control hub 340 controls the operations of main memory 320, and mass storage device 360. A number of input/output devices 370 such as a keyboard, wireless interface, mouse and/or display may be coupled to bus 330.

Although system 300 is illustrated as a system with a single processor, other embodiments may be implemented with multiple processors, in which additional processors may be coupled to the bus 330. In such cases, each additional processor may share main memory 320 for writing data and/or instructions to and reading data and/or instructions from the same.

Response processing system 300 decodes selective response data received from an RFID reader (not shown). The reader may process the selective response data into another format, for example, into Extensible Markup Language (XML). Alternatively, the reader may send raw selective response data to system 300 that may use higher level application software to decode the selective response data. For example, by processing time stamps and/or identification codes, a pattern of selective responses may be derived. The pattern of selective responses may be decoded to determine the sensor information. According to alternate embodiments of the present invention, raw received selective response data, XML or other formatted data may be accumulated and decoded at a later time.

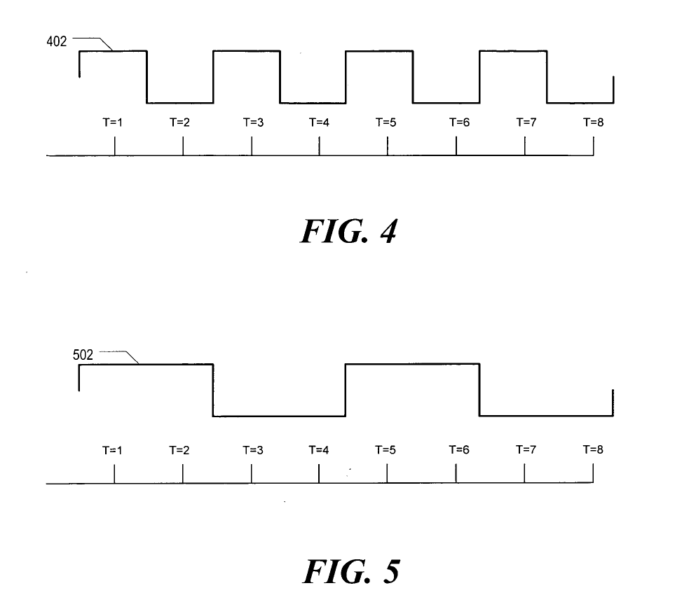

According to embodiments of the present invention, many types of time-dependent response encoding may be used. For example, in the simplest form, a response (R) may represent a one, and a non-response (NR) may represent a zero. Another simple form may include a response with a first identification code (ID1) and a response with a second identification code (ID2). More sophisticated coding schemes may be used to provide greater reliability. For example, a framing sequence (for example, R, R, R or a Barker code) might be followed by Manchester coded bits: R, NR to represent a 0 and NR, R to represent a 1. More complex modulation schemes, such as frequency shift keying as illustrated in FIGS. 4 and 5, pulse width modulation, pulse code modulation, or direct sequence spread spectrum, may also be used.

In alternate embodiments of the present invention, more bits per symbol can be achieved by allowing the tag to communicate using a response with a first identification code, a response with a second identification code, and a non-response, three symbol values in total. Further, additional identification codes may be used to increase the number of symbol values. The invention is not intended to be limited in this respect.

FIGS. 4 and 5 illustrate response encoding diagrams according to embodiments of the present invention. Referring to FIG. 4, wave 402 illustrates a series of responses and non-responses from an RFID tag. For example, a high state on wave 402 illustrates response to an RFID poll, and a low state on wave 402 illustrates a non-response to an RFID poll. Alternatively a high state on wave 402 may illustrate a response with a first identification code and a low state on wave 402 may illustrate a response with a second identification code. RFID reader may record responses by storing the identification received and/or time stamps. Referring to FIG. 5, wave 502 illustrates another series of responses and non-responses from an RFID tag. The RFID reader may record responses by storing the identification received along with time stamps T1, T2, T5 and T6. The on-off-on-off pattern of wave 402 may indicate an embedded frequency shift keyed “0” value and the on-on-off-off pattern of wave 502 may indicate an embedded frequency shift keyed “1” value. By stringing together a series of selective responses, an RFID tag may be able to communicate to a RFID reader a state of an attached sensor.

According to an alternate embodiment of the present invention, an RFID reader may have the capability to record non-responses as well responses.

According to an alternate embodiment of the present invention, a host application may download multiple identification codes to an RFID reader such that the reader may extract sensor values from a series of selective responses. For example, identification codes may be downloaded in pairs to decode sensor data locally.

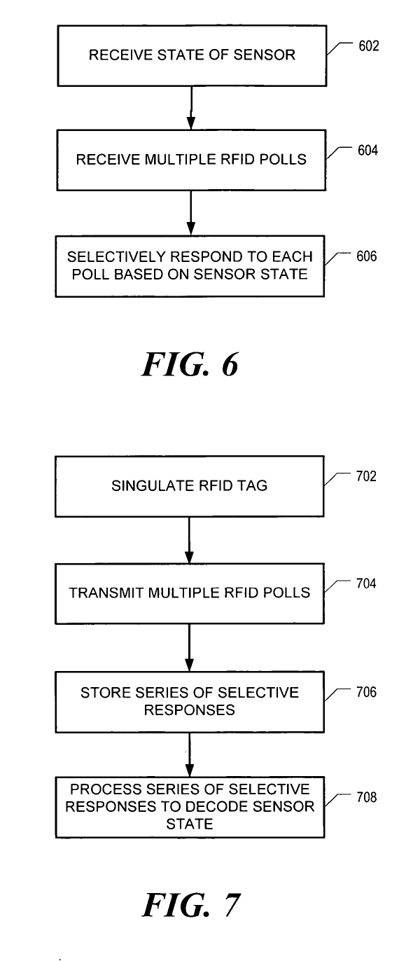

FIG. 6 illustrates a flow diagram performed by an RFID tag according to an embodiment of the present invention. The RFID tag receives a current state of an attached sensor, block 602. Receiving sensor state may occur at various times, for example, continuously, at various specified times, at the direction of the sensor, or upon receipt of a poll. The RFID tag receives multiple RFID polls, block 604. The sensor state may be stored in the RFID tag memory. The RFID tag selectively responds to each of the multiple polls based on the sensor state, block 606, encoding sensor data.

FIG. 7 illustrates a flow diagram of an RFID reader and associated response processing system according to an embodiment of the present invention. The RFID reader may singulate an RFID tag, block 702. The RFID reader transmits multiple RFID polls to the RFID tag, block 704. A series of selective responses may be stored, block 706. Alternatively, instead of storing the series, the selective responses may be immediately processed. The associated response processing system processes the series of selective responses, determining the pattern of selective responses, to decode sensor state, block 708.

Although the above embodiments have been illustrated with reference to RFID communications, other types of wireless communication systems are intended to be within the scope of the present invention including, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect. In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. An apparatus comprising:
a radio frequency identification (RFID) tag to selectively respond in a vector of selective responses to a plurality of signals from an RFID reader;
wherein the vector of selective responses encodes information.

2. The apparatus as recited in claim 1, wherein the vector of selective responses comprises one or more responses and one or more non-responses.

3. The apparatus as recited in claim 1, wherein the vector of selective responses comprises one or more responses with a first identification code and one or more responses with a second identification code.

4. The apparatus as recited in claim 1, wherein the vector of selective responses comprises one or more responses with a first identification code, one or more responses with a second identification code, and one or more non-responses.

5. The apparatus as recited in claim 1, wherein the information comprises sensor information.

6. The apparatus as recited in claim 5, wherein the sensor information comprises a temperature.

7. The apparatus as recited in claim 5, wherein the sensor information comprises a humidity level.

8. The apparatus as recited in claim 1, the RFID tag comprising:
an antenna to receive the plurality of signals from the RFID reader;
power harvesting circuitry coupled to the antenna to harvest power from the plurality of signals; and
a state machine configured to selectively respond to the plurality of signals.

9. The apparatus as recited in claim 1, wherein the plurality of signals from the RFID reader comprises a plurality of RFID polls.

10. The apparatus as recited in claim 1, wherein the information is encoded in a frequency shift keying coding scheme.

11. The apparatus as recited in claim 1, wherein the information is encoded in a pulse width modulation scheme.

12. The apparatus as recited in claim 1, wherein the information is encoded in a pulse code modulation scheme.

13. The apparatus as recited in claim 1, wherein the information is encoded in a Manchester coding scheme.

14. A method comprising:
receiving a plurality of radio frequency identification (RFID) polls; and
selectively responding to each of the RFID polls in a series of selective responses to encode additional information.

15. The method as recited in claim 14, wherein the series of selective responses comprises one or more responses and one or more non-responses.

16. The method as recited in claim 14, wherein the series of selective responses comprises one or more responses with a first identification code and one or more responses with a second identification code.

17. The method as recited in claim 14, wherein the additional infonnation is a state of a device.

18. The method as recited in claim 14, wherein the additional information is encoded in a frequency shift keying coding scheme.

19. A method comprising:
receiving a plurality of selective radio frequency identification (RFID) responses from an RFID tag; and
processing the plurality of selective RFID responses to decode encoded information.

20. The method as recited in claim 19, wherein at least one of the plurality of selective RFID responses is different from another of the plurality of selective RFID responses.

21. The method as recited in claim 19, wherein the plurality of selective RFID responses comprises one or more responses and one or more non-responses.

22. The method as recited in claim 19, wherein the plurality of selective RFID responses comprises one or more responses with a first identification code and one or more responses with a second identification code.

23. The method as recited in claim 19, wherein receiving the plurality of selective RFID responses comprises storing a time stamp when each of the plurality of selective RFID responses is received.

24. An apparatus comprising:
input circuitry configured to receive a plurality of selective radio frequency identification (RFID) responses; and
a processor configured to process the selective RFID responses to decode encoded information.

25. The apparatus as recited in claim 24, wherein the input circuitry further configured to store a time stamp when each of the plurality of RFID responses is received.

26. The apparatus as recited in claim 24, wherein the plurality of selective RFID responses comprises one or more responses and one or more non-responses.

27. The apparatus as recited in claim 24, wherein the plurality of selective RFID responses comprises one or more responses with a first identification code and one or more responses with a second identification code.

28. The apparatus as recited in claim 27, wherein the processor further to:
process each time stamp to determine a series of received responses and non-received responses; and
decode the series of received responses and non-received responses to decode the encoded information.

29. An article comprising:
a machine-readable medium that provides instructions, which when executed by a computing platform, cause said computing platform-to perform operations comprising:
receiving a plurality of radio frequency identification (RFID) responses; and
processing the RFID responses to decode encoded information.

30. The article as recited in claim 29, wherein receiving the plurality of RFID responses comprises storing a time stamp when each of the plurality of RFID responses is received.

31. The article as recited in claim 30, wherein processing the RFID responses comprises:
processing each time stamp to determine a series of received responses and non-received responses; and
decoding the series of received responses and non-received responses to decode the encoded information.

32. The article as recited in claim 29, wherein the encoded information is encoded in a Manchester coding scheme.
